(19) United States
(12) Patent Application Publication
(10) Pub. No.: US 2005/0246478 A1
(43) Pub. Date: Nov. 3, 2005

(54) Information processing apparatus and a method and a program of loading a device driver

(75) Inventor: Kenichi Tanaka, Tokyo (JP)

Correspondence Address: MICHAEL BEST & FRIEDRICH LLC, 401 NORTH MICHIGAN AVENUE, SUITE 1900, CHICAGO, IL, 60611-4212, US

(73) Assignee: NEC Corporation, Tokyo (JP)

(21) Appl. No.: 11/072,078

(22) Filed: Mar. 4, 2005

(30) Foreign Application Priority Data
May 3, 2004 (JP) 2004-062419

(51) Int. Cl. G06F 13/36

(52) U.S. Cl. 710/315

(57) ABSTRACT

Disclosed is a computer system in which a driver for controlling a non-PCI device can be installed using a plug and play function of the PCI device. In a computer system having the PCI devices, a configuration space header region of a virtual PCI device that stores the vendor ID and the device ID of the virtual PCI device corresponding to a non-CPI device is provided on a medium to which a system BIOS can refer. At the time of booting, in order to search for a PCI device included in the system, an operating system inquires the system BIOS. The system BIOS returns the vendor ID and the device ID of the PCI device, for the PCI device included in the system, and returns the vendor ID and the device ID of the virtual PCI device, for the non-PCI device. Then, the operating system searches for a driver for the virtual PCI device, and loads the corresponding driver. When the virtual PCI device uses an interrupt, the information that the interrupt is accommodated is set in an interrupt pin register.

This application claims priority of Japanese patent application no. 2004-062419 filed Mar. 5, 2004.

### FIELD OF THE INVENTION

The present invention relates to an information processing apparatus. More specifically, the invention relates to a method, a device, and a program of loading a device driver.

### BACKGROUND OF THE INVENTION

In a computer system that include at least one PCI (Peripheral Component Interconnect) compliant device (referred to as ‘PCI device’), an operating system that supports a plug and play function for controlling the PCI device searches through PCI configuration space of the PCI device via a system BIOS (Basic Input/Output System) to identify each PCI device mounted on the computer system. The operating system thereby loads a suitable driver (also referred to as a “device driver” or an “I/O driver”) required for the PCI device and controls the PCI device.

On the other hand, in a device with a bus interface and the like being different from those in PCI specifications (referred to as ‘non-PCI device’), a general approach that associates the device with the driver thereof is not present. Thus, before mounting of the device on the system, it is necessary to link the driver to the kernel of the operating system by modifying the operating system or the like in advance. When the operating system cannot be modified, it is extremely difficult to install the driver for controlling the non-PCI device on the operating system.

A configuration of a computer system having a plurality of adapters for connecting a plurality of input/output devices and a plurality of input/output control programs (device drivers) for controlling these is known in which adapter identifiers are provided for the adapters, and at the time of initialization of the computer system, a CPU reads the identifiers, only necessary device drivers among device drivers in an auxiliary storage device are linked to create an operating system, and the created operating system is loaded into a main storage (refer to Patent Document 1, for example). Further, though being different from a virtual PCI device used for the present invention that will be described later in the meaning of “virtual”, a configuration is known in which linkage is made between a device driver of an operating system that runs on a virtual resource operating system as a virtual machine (VM) and a corresponding real device and a virtual device of a virtual resource manager (refer to Patent Document 2, for example).

[Patent Document 1] JP Patent Kokai Publication No. JP-A-8-63420 (FIG. 1)

[Patent Document 2] JP Patent Kokai Publication No. JP-A-61-201341 (FIG. 1)

### SUMMERY OF THE DISCLOSURE

As described above, in regard to a device different from the PCI device, to which a general approach to associating the device with the driver thereof is not present, it becomes necessary to modify the operating system in advance and links the driver to the kernel of the operating system, when the device is mounted on the system. For this reason, when the operating system cannot be modified, there is the problem that it is difficult to install the driver for controlling the non-PCI device on the operating system.

Accordingly, it is an object of the present invention to provide a system, a method, and a computer program that can easily install a driver for controlling a device such as a non-PCI device on a computer system.

The above and other objects are attained by the present invention having a configuration described below.

An information processing apparatus in accordance with one aspect of the present invention is adapted to include at least one first device complying with predetermined bus interface specifications and at least one second device having interface specifications different from the bus interface specifications. Then, besides a configuration space provided for the first device and storing at least identification information on the first device, a virtual configuration space region for the second device with at least one part common to the configuration space in format is provided in the storage unit of the information processing apparatus.

In the information processing apparatus according to the present invention, preferably, at least virtual identification information on the second device is stored in the virtual configuration space region.

In the information processing apparatus according to the present invention, at the time of booting, for the first device included in the information processing apparatus, the identification information on the first device is obtained from the configuration space of the first device, and a driver corresponding to the first device is loaded, and for the second device included in the information processing apparatus, the virtual identification information is obtained from the virtual configuration space region associated with the second device, and a driver corresponding to the second device is loaded.

When installing a driver of an information processing apparatus including at least one first device complying with predetermined bus interface specifications and at least one second device having interface specifications different from the bus interface specifications, a method according to other aspect of the present invention includes the steps of: providing, besides a configuration space provided for the first device and storing at least identification information on the first device, a virtual configuration space region for the second device in the storage unit of the information processing apparatus, and then storing at least virtual identification information on the second device in the virtual configuration space region, the virtual configuration space region having at least one part common to the configuration space in format; and obtaining the identification information on the first device from the configuration space of the first device, and loading a driver corresponding to the first device, for the first device, and obtaining the virtual identification information from the virtual configuration space region associated with the second device, and loading a driver corresponding to the second device, for the second device, at the time of booting.

A computer program in accordance with another aspect of the present invention comprises the program for causing a computer including at least one first device complying with predetermined bus interface specifications and at least one second device having interface specifications different from the bus interface specifications to execute the processing of: providing, beside a configuration space provided for the first device and storing at least identification information on the first device, a virtual configuration space region for the second device in a predetermined storage unit, and then storing at least virtual identification information on the second device in the virtual configuration space region, the virtual configuration space region having at least one part common to the configuration space in format; and obtaining the identification information on the first device from the configuration space of the first device, and loading a driver corresponding to the first device, for the first device, and obtaining the virtual identification information from the virtual configuration space region associated with the second device, and loading a driver corresponding to the second device, for the second device, at the time of booting.

In the present invention, the system BIOS causes the non-PCI device to appear to be a PCI device. The operating system thereby installs a corresponding driver into a computer system.

In a computer system according to still another aspect of the present invention, including at least one PCI (Peripheral Component Interface) device and at least one non-PCI device, a storage region storing at least predetermined identification information on a virtual PCI device associated with the non-PCI device is provided for a system BIOS (Basic Input/Output System); at the time of booting, an operating system inquires the system BIOS so as to search for the PCI device included in the computer system; the system BIOS returns to the operating system identification information on the PCI device, for each PCI device included in the computer system, and returns to the operating system the identification information on the virtual PCI device, for the non-PCI device; and the operating system receives the identification information from the system BIOS, searches for a driver corresponding to the virtual PCI device from a driver library, and loads the driver searched for as a driver corresponding to the non-PCI device.

In the present invention, a header region for the configuration space of the virtual PCI device may be disposed on a medium that can be referred to by the system BIOS, and a predetermined vendor ID and a predetermined device ID may be stored in the header region as the predetermined identification information on the virtual PCI device.

In the present invention, when the non-PCI device uses an interrupt, information indicating that the interrupt is accommodated may be set in an interrupt pin register provided for the header region for the configuration space of the virtual PCI device.

In the present invention, the operating system may inquire the system BIOS whether the virtual PCI device has the interrupt or not, and the system BIOS may return the set information indicating the that the interrupt is accommodated in case the non-PCI device uses the interrupt; and the operating system may determine that the virtual PCI device has the interrupt and may register an interrupt handler.

The meritorious effects of the present invention are summarized as follows.

According to the present invention, when installing the driver for controlling the non-PCI device into the computer system using a plug and play function for the PCI device, the system BIOS causes the non-PCI device to appear to be a PCI device. The operating system can thereby easily install the corresponding driver into the computer system.

Further, according to the present invention, by creating the driver for the non-PCI device as the common PCI device driver, the driver can be installed into the operating system without modifying the operating system.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing a configuration of an embodiment of the present invention.

FIG. 2 is a diagram for explaining a procedure for loading a PCI device driver in the embodiment of the present invention.

FIG. 3 is a diagram for explaining a procedure for loading a non-PCI device driver in the embodiment of the present invention.

FIG. 4 is a diagram for explaining a PCI configuration space in the embodiment of the present invention.

FIG. 5 is a flowchart for explaining the procedure for loading the PCI device driver in the embodiment of the present invention.

FIG. 6 is a flowchart for explaining the procedure for loading the non-PCI device driver in the embodiment of the present invention (corresponding to step 5A in FIG. 5).

### PREFERRED EMBODIMENTS OF THE INVENTION

The present invention will be described with reference to the appended drawings so as to describe the invention in further detail.

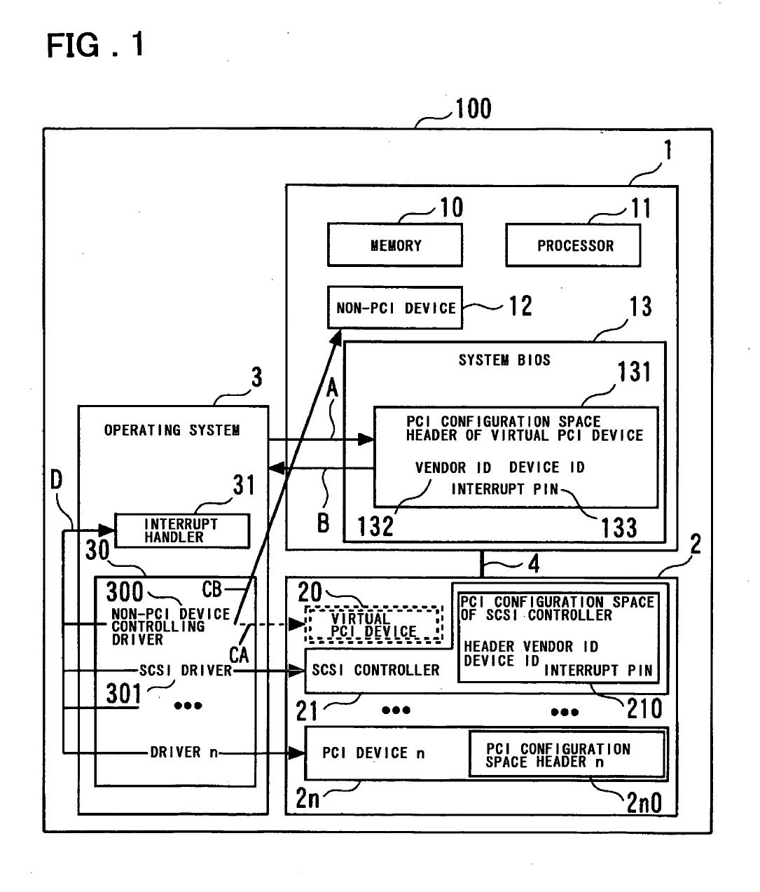

FIG. 1 is a diagram showing a configuration of a best mode for carrying out the invention. Referring to FIG. 1, when referring to a PCI configuration space in a computer system (100) according to this embodiment mode, an operating system (3) inquires a system BIOS (13), and the system BIOS (13) returns values. Before the operating system (3) is booted, the PCI configuration space of a virtual PCI device corresponding to a non-PCI device (12) is included in the computer system (100) in advance. Specifically, a PCI configuration space header region (131) is virtually defined on a medium that can be referred to from the system BIOS (13), and a vendor ID and a device ID (132) that have been determined in advance as the virtual PCI device corresponding to the non-PCI device are set (in first setting).

When the non-PCI device (12) uses an interrupt, information indicating “presence of the interrupt” (i.e., indicating that the interrupt is implemented) is set in advance in an interrupt pin register (133) of the configuration space header region of a virtual PCI device (20) so as to show that the interrupt is implemented in the virtual PCI device (20) corresponding to the non-PCI device (12) (in second setting).

At the time of booting, in order to search for a PCI device included in the computer system, the operating system (3) inquires the system BIOS about the PCI configuration space header region of the device (as shown in processing indicated by an arrow A in FIG. 1).

The system BIOS (13) returns the vendor ID and the device ID of the PCI device for the PCI device included in the system.

The system BIOS (13) returns the vendor ID and device ID (132) of the virtual PCI device (20) for the non-PCI device (12) that has been set in the “first setting” described above (as shown in processing indicated by an arrow B in FIG. 1). Using the IDs given from the system BIOS (13), the operating system (3) searches for a driver (300) for the virtual PCI device (20), and loads the corresponding driver (non-PCI driver 300) into a main storage (as shown in processing indicated by arrows CA and CB in FIG. 1).

Further, the operating system (3) inquires the system BIOS (13) whether the virtual PCI device (20) has an interrupt or not. When the non-PCI device (12) uses the interrupt, the system BIOS (13) returns to the operating system (3) the information indicating the “presence of the interrupt” set in the interrupt pin register (133) of the configuration space header region of the virtual PCI device in the “second setting” described above.

Upon receipt of this, the operating system (3) determines that the virtual PCI device (20) has the interrupt, and registers an interrupt handler (as shown in processing indicated by an arrow D in FIG. 1).

As described above, according to this embodiment mode, using the mechanism of loading a common PCI device driver into the operating system including the plug and play function of PCI device, the driver (300) for the non-PCI device (12) can be installed into the operating system. A detailed description will be given below in connection with a specific embodiment.

### Embodiments

FIG. 1 is a diagram showing a configuration of an embodiment of the present invention. Referring to FIG. 1, in a computer system (100) that constitutes the embodiment of the present invention, a mother board (1) including a memory (10), a processor (11), a non-PCI device (12), and a system BIOS (13) is connected to PCI devices (2) via a PCI bus (4). The PCI devices (2) include n PCI devices (21, . . . , and 2n) such as SCSI (Small Computer System Interface) controllers.

Each of the PCI devices (2) includes PCI configuration spaces (210, . . . , or 2n0) inside.

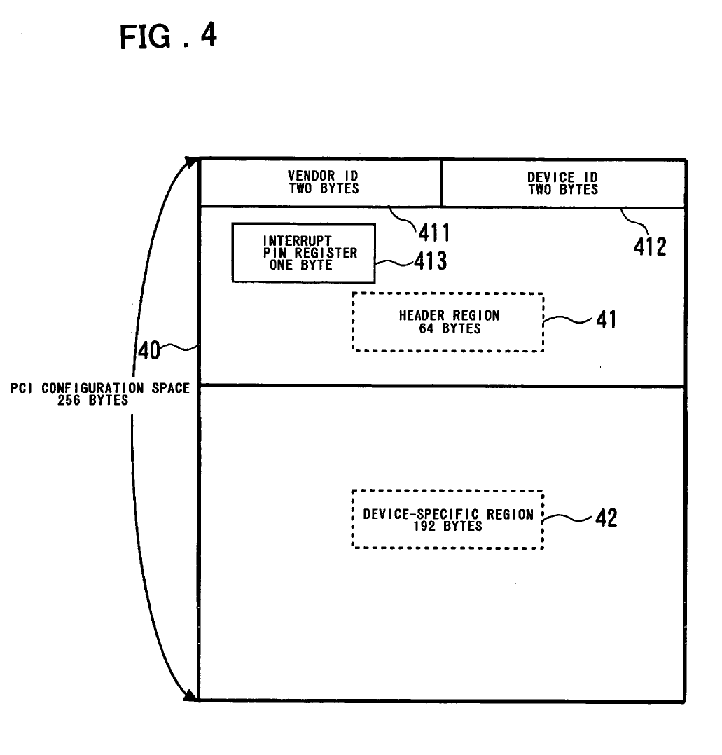

FIG. 4 is a diagram schematically showing a configuration of a PCI configuration space shown in FIG. 1. A PCI device includes a PCI configuration space (40) within the device. The PCI configuration space (40) is used for detection of and control over the PCI device.

As shown in FIG. 4, the PCI configuration space (40) is a 256-byte address space, and is constituted from a 64-byte header region (41) that does not depend on the type of the device and a 192-byte device-specific region (42). For the header region (41), a vendor ID register (411) (with the size of two bytes) and a device ID register (412) (with the size of two bytes) are provided, and they are used for identifying the vendor that manufactures the device and the type of the device. For the header region (41), an interrupt pin register (413) (with the size of one byte) is provided, and is used for identifying an interrupt line used by the device.

Codes (such as instruction codes) of the system BIOS (13) are expanded on the memory (10), and the processor (11) for booting up the system executes the codes at the time of system startup. After the system has been initialized by the system BIOS (13), the system BIOS (13) boots an operating system (3). The operating system (3) has a plug and play function for the PCI devices (2).

Generally, a driver for the operating system (3) for controlling the PCI device has information indicating correspondence between the driver and the device having the vendor IDs and the device ID. An SCSI driver (301), for example, has information indicating a correspondence between the driver and the device having the vendor ID and the device ID recorded in the header region of the PCI configuration space (210) in the SCSI controller (21). Further, the driver for controlling the PCI device accommodated for the system is stored in a driver library (30) inside the operating system (3), in advance.

In this embodiment, to a driver (300) for controlling the non-PCI device (12), information indicating a correspondence between the driver and the device having the vendor ID and the device ID in the header region of a PCI configuration space (131) of a virtual PCI device set by the system BIOS (13) is given.

Further, in the operating system (3) in this embodiment, like the routine driver for controlling the PCI device, the driver (300) for controlling the non-PCI device (12) is included in the driver library (30), in advance.

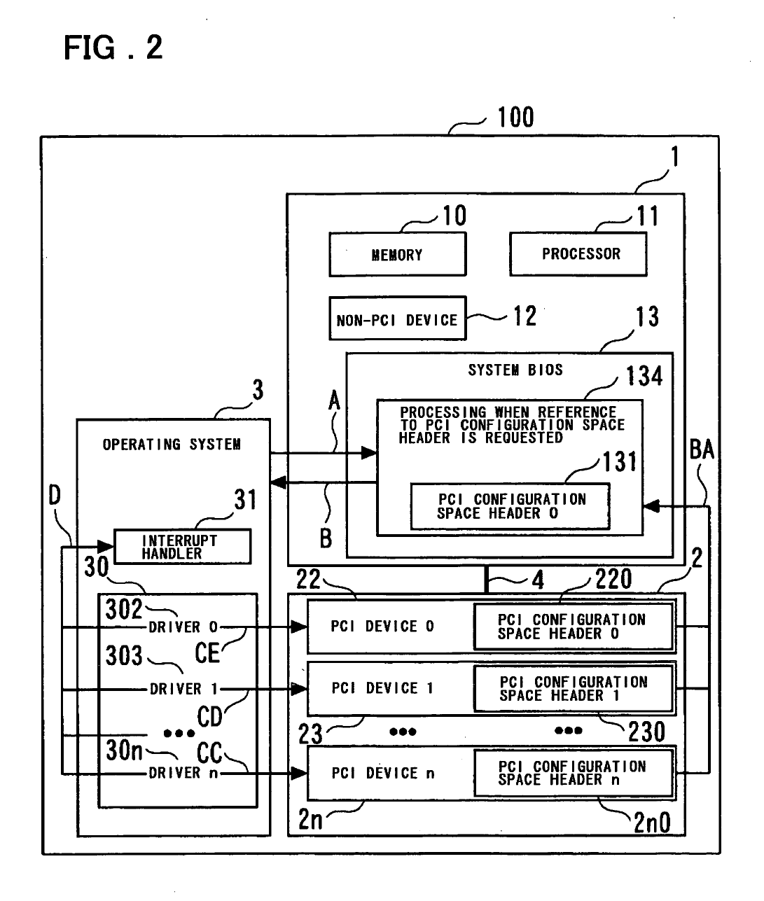

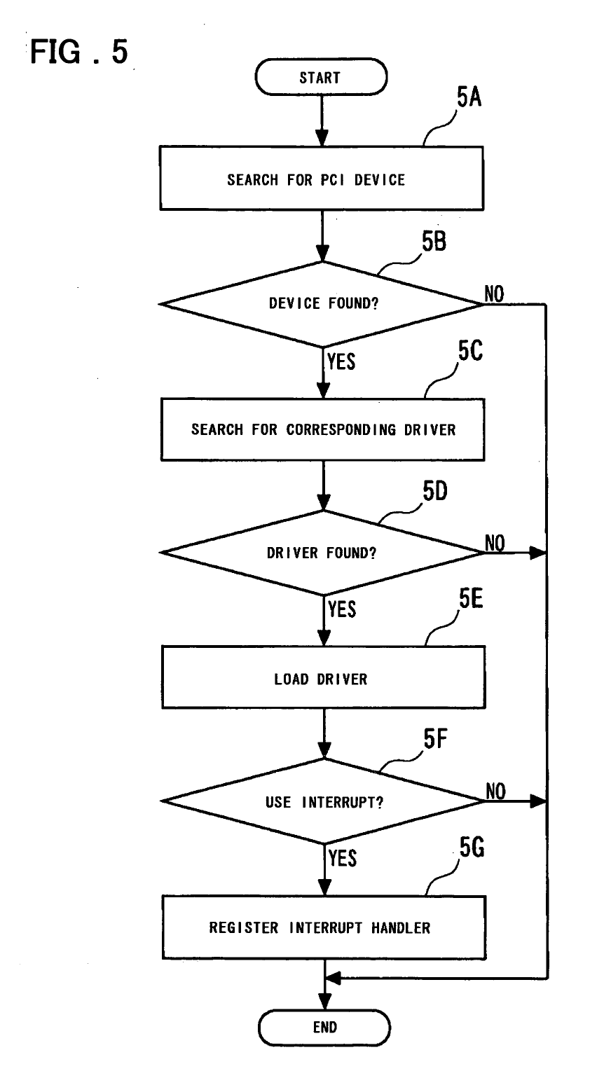

FIG. 2 is a diagram for illustrating processing for installing the driver for controlling the PCI device in the operating system adapted for plug and play of the PCI device. FIG. 5 is a flowchart for explaining processing procedures according to the embodiment of the present invention.

Referring to FIG. 2 and the flowchart in FIG. 5, processing for installing the driver for controlling the PCI device into the operating system adapted for plug and play of the PCI device will be described below.

As in most instances, in the present embodiment as well, installation of the driver for controlling the PCI device into the operating system (3) that supports the plug and play of the PCI device is performed using the following procedure.

First, the operating system (3) searches for a PCI device by referring to the header regions of the PCI configuration spaces (220, 230, . . . , and 2n0) of the PCI devices (22, 23, . . . , and 2n) with respect to all bus numbers, device numbers, and function numbers (at step 5A in FIG. 5). “0×FFFF” and “0×FFFF” of the vendor IDs and the device IDs in the header regions of the PCI configuration spaces (220, 230, . . . , and 2n0) corresponding to the bus numbers, device numbers, and function numbers for which the PCI devices are not present, are returned, respectively, according to PCI specifications. Accordingly, detection of the PCI device means the case where none of the vendor IDs and the device IDs of the PCI configuration space header regions referred to were “0×FFFF”.

In the computer system (100) in this embodiment, when the operating system (3) refers to the PCI configuration spaces (220, 230, . . . , and 2n0), the operating system (3) does not directly refer to the PCI configuration spaces included in the PCI devices, but inquires the system BIOS (13) (as shown in processing indicated by an arrow A in FIG. 2). The system BIOS (13) refers to the PCI configuration spaces of the PCI devices (as shown in processing indicated by an arrow BA in FIG. 2), and returns the values to the operating system (3) (as shown in processing indicated by an arrow B in FIG. 2).

Then, when the PCI device is detected (at step 5B in FIG. 5), the operating system (3) retrieves the driver corresponding to the PCI device that has the vendor ID and the device ID of the detected PCI device (22, 23, . . . , or 2n) from the driver library (30) inside the operating system (3) (at step 5C in FIG. 5). Specifically, retrieval in the driver library (30) is performed as follows.

The driver of a PCI device has the mechanism in which upon receipt of the vendor ID and the device ID of a PCI device from the operating system (3), the driver makes a response indicating whether the driver corresponds to the device having the vendor ID and the device ID. In the operating system (3), drivers (302, 303, . . . , and 30n) corresponding to the various PCI devices are stored in the driver library (30). The operating system (3) gives the vendor ID and the device ID of the PCI device searched for by the system BIOS (13) to the drivers (302, 303, . . . , and 30n) for all the PCI devices in the driver library (30), and receives responses from the drivers (302, 303, . . . , and 30n) indicating whether they correspond to the device having the device ID and the vendor ID of the detected device. With this arrangement, the operating system (3) recognizes which driver the driver for controlling the PCI device searched for by the system BIOS (13) is (at step 5C in FIG. 5).

When the driver for controlling the PCI device is detected (at step 5D in FIG. 5), the operating system (3) loads the driver.

The operating system (3) performs the driver loading processing described above on all the PCI devices (22, 23, . . . , and 2n) detected. As a result, the operating system (3) can load the drivers included in the system (as shown in processing indicated by arrows CC, CD, and CE in FIG. 2) (at step 5E in FIG. 5).

When the drivers (302, 303, . . . , and 30n) for controlling the PCI devices use an interrupt, the drivers make a request for registering an interrupt handler (31) to the operating system (3).

Upon receipt of the request for registering the interrupt handler, the operating system (3) looks at the interrupt pin register in the PCI configuration space header region of the PCI device to check whether the interrupt mechanism is accommodated in the PCI device (at step 5F in FIG. 5).

According to the PCI specifications, when the value of the interrupt pin register in the PCI configuration space header region is “zero”, it means that the interrupt is not used by the PCI device. When the value of the interrupt pin register is “one”, “two”, “three”, or “four”, it means that the PCI device uses the interrupt.

When it is found that the interrupt is accommodated in the PCI device, the operating system (3) assigns an interrupt vector to the PCI device, and registers the interrupt handler (31) associated with the PCI device in the interrupt vector (as shown in processing indicated by an arrow D in FIG. 2) (at step 5G in FIG. 5).

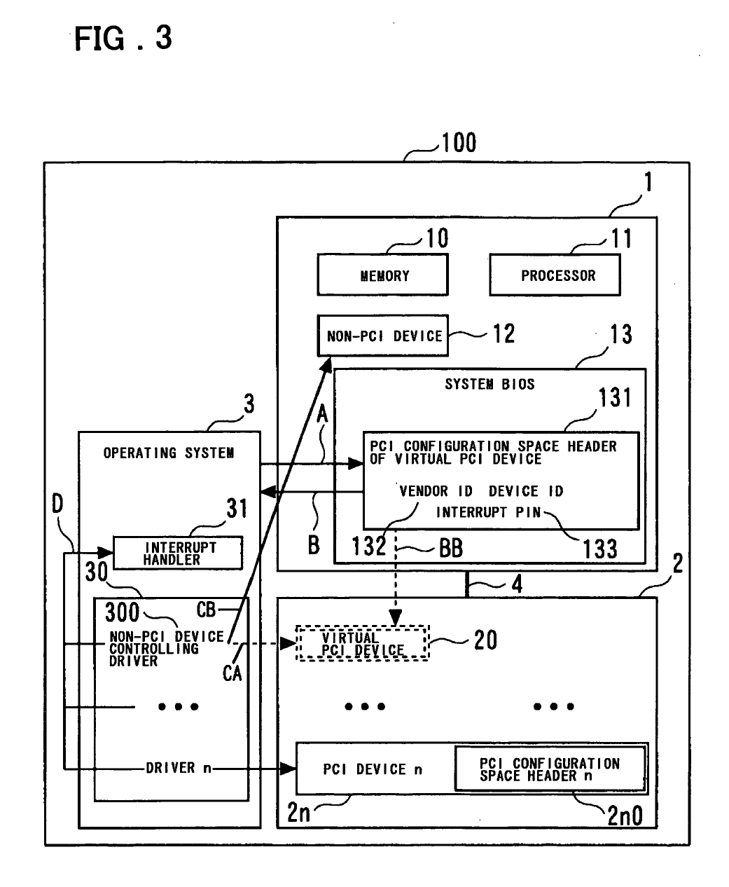

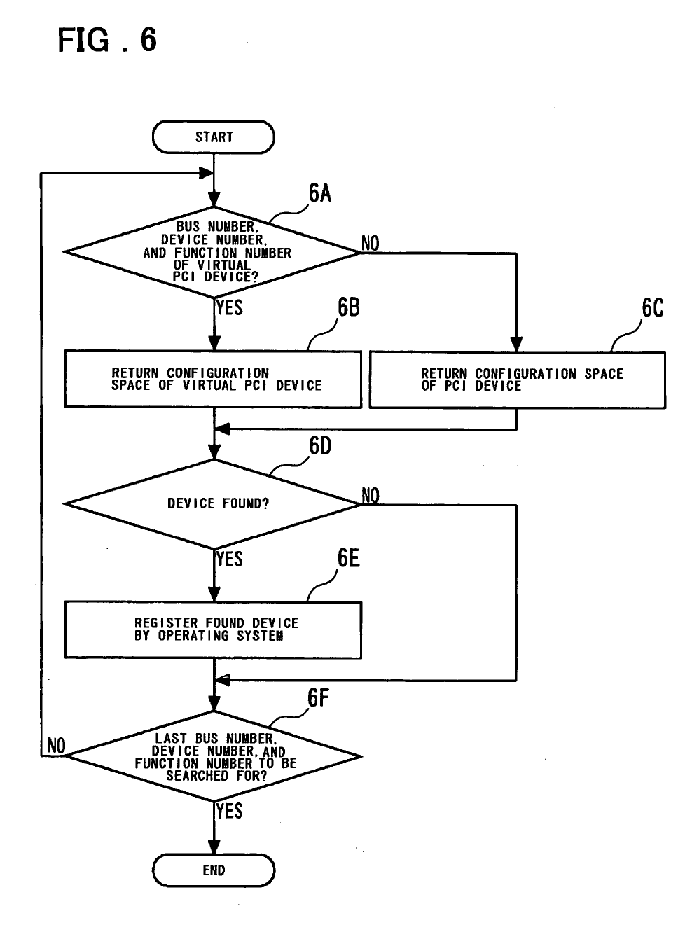

Next, FIG. 3 is a diagram for explaining processing for installing the driver for controlling the non-PCI device into the operating system (3) that supports the plug and play of the PCI devices in this embodiment shown in FIG. 1. FIG. 6 is a flowchart showing its processing procedure. Referring to FIGS. 3 and 5 and FIG. 6, the processing for installing the driver for controlling the non-PCI device into the operating system that supports the plug and play of the PCI devices will be described below.

The operating system (3) that supports the plug and play of the PCI devices refers to the configuration spaces of the PCI devices with respect to all bus numbers, device numbers, and function numbers, for search for a PC device, according to the common procedure for installing the PCI device driver described with reference to FIGS. 2 and 5 (at step 5A in FIG. 5).

In the computer system in this embodiment, when the operating system (3) refers to the PCI configuration spaces, the operating system (3) does not directly refers to the PCI configuration spaces included in the PCI devices, but inquires the system BIOS (13) (as shown in processing indicated by an arrow in FIG. 3). Then, the system BIOS (13) refers to the PCI configuration spaces in the PCI devices and returns the values (as shown in processing indicated by an arrow B in FIG. 3).

Next, step 5A in FIG. 5 will be described in detail with reference to FIG. 6. The PCI device can be uniquely identified by the bus number, device number, and function number thereof. The operating system (3) searches for the PCI device included in the system using these numbers.

In this embodiment, during initialization of the system, the system BIOS (13) includes on the memory (10) a PCI configuration space header region corresponding to the bus number, device number, and function number that do not match any of the bus numbers, device numbers, and function numbers of the PCI devices really included, and sets, in the region of the memory, the values of a vendor ID, a device ID, and an interrupt pin that have been determined in advance. With this setting, the PCI configuration space header region of the PCI device that does not really present or a virtual PCI device has been set.

The system BIOS (13) determines whether the operating system (3) is to refer to the PCI configuration space header region having the bus number, device number, and function number of the virtual PCI device (at step 6A in FIG. 6). If so (as shown in branching to YES at step 6A in FIG. 6), the system BIOS (13) returns a PCI configuration space header region (131) of the virtual PCI device that has been set by the system BIOS (13) (at step 6B in FIG. 6).

When the operating system (3) is not to refer to the PCI configuration space header region having the bus number, device number, and function number of the virtual PCI device (as shown in branching to NO at step 6A in FIG. 6), the system BIOS returns the PCI configuration space header region of the normal PCI device (at step 6C in FIG. 6).

The operating system (3) looks at the vendor ID and the device ID, thereby determining whether the PCI device has been detected or not (at step 6D in FIG. 6).

When the PCI device is detected (as shown in branching to YES at step 6D in FIG. 6), the operating system (3) registers the PCI device which has been detected using the bus number, device number, and function number thereof (at step 6E in FIG. 6). At this point, the operating system (3) determines that a virtual PCI device (20) is identified by the bus number, device number, and function number of the virtual PCI device (as shown in processing indicated by an arrow BB in FIG. 3).

Next, the operating system (3) determines whether the bus number, device number, and function number are the last ones to be searched for (at step 6F in FIG. 6). If so (as shown in branching to YES at step 6F in FIG. 6), the operating system (3) finishes the search of the device. On the other hand, when the search is not finished (branching to NO at step 6F in FIG. 6), the operation is returned to step 6A in FIG. 6, and the operating system continues the search.

Next, when the search for the PCI device (at step 5A in FIG. 5) is completed, the operating system (3) determines whether the PCI device has been detected or not (at step 5B in FIG. 5). When the device is detected (as shown in branching to YES at step 5B in FIG. 5), the operating system (3) searches through the driver library (30) within the operating system associated with the PCI device having the vendor ID and the device ID of the detected PCI device (at step 5C in FIG. 5). At this point, the operating system (3) determines that the virtual PCI device (20) has been included. Thus, the operating system (3) searches for the driver corresponding to the PCI device having the vender ID and the device ID of the virtual PCI device (20).

The driver (300) for controlling the non-PCI device (12) is included in the driver library (30) as the driver (non-PCI driver 300) for the PCI device for controlling the PCI device having the vender ID and the device ID of the virtual PCI device (20). For this reason, when this driver receives the vendor ID and the device ID of the virtual PCI device (20) from the operating system (3), the driver makes a response indicating that the driver supports the virtual PCI device (20).

Thus, the operating system (3) determines that the driver for controlling the virtual PCI device (20) is the driver (300) for controlling the non-PCI device (as shown in branching to YES at step 5D in FIG. 5), and loads the driver (as shown in processing indicated by arrows CA and CB in FIG. 3) (at step 5E in FIG. 5).

Further, when the driver (300) for controlling the non-PCI device (12) uses an interrupt, the driver makes a request for registering the interrupt handler (31) to the operating system (3), according to the procedure for registering the interrupt handler by the common PCI device driver. When the operating system (3) receives the request for the registration, the operating system looks at the interrupt pin register in the PCI configuration space header region of the virtual PCI device (20), and checks whether the PCI device has the interrupt or not (at step 5F in FIG. 5).

In an interrupt pin register (133) in the PCI configuration space of the virtual PCI device (20), an appropriate value other than “zero” is set by the system BIOS (13) in advance. The operating system (3) inquires the system BIOS (13) so as to refer to the interrupt pin register in the PCI configuration space header region. The system BIOS (13) then returns the value of the interrupt pin register (133) of the virtual PCI device (20) to the operating system (3).

The operating system (3), which has received the value of the interrupt pin register (133) from the system BIOS (13), determines that the virtual PCI device (20) has the interrupt and registers the interrupt handler.

When it is found that the virtual PCI device (20) has the interrupt, the operating system (3) assigns the interrupt vector to the virtual PCI device (20), and registers the interrupt handler (31) in the interrupt vector (as shown in processing indicated by an arrow D in FIG. 3) (at step 5G in FIG. 5).

By the procedure described above, the driver (300) for controlling the non-PCI device can be installed into the operating system (3).

An operation and effect of this embodiment will be described below.

According to this embodiment, when the driver for controlling the non-PCI device is installed into the operating system that supports the plug and play of the PCI devices in the computer system having the non-PCI device, the driver for the non-PCI device is created as the common PCI device driver. The driver can be thereby installed into the operating system without modifying the operating system.

Though the present invention has been described in connection with the embodiment described above, the present invention is not limited to the above-mentioned configuration of the embodiment alone, and of course includes various variations and modifications that could be made by those skilled in art within the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

1. An information processing apparatus adapted to include, besides at least one first device complying with predetermined bus interface specifications, at least one second device having interface specifications different from said predetermined bus interface specifications, said information processing apparatus comprising:
a virtual configuration space region for said second device, arranged in a storage unit of said information processing apparatus; said virtual configuration space region storing at least virtual identification information on said second device; and
a system for obtaining, for said second device, the virtual identification information from said virtual configuration space region associated with said second device, and loading a driver corresponding to said second device.

2. The information processing apparatus according to claim 1, wherein said system obtains, for said first device included in said information processing apparatus, identification information on said first device from configuration space of said first device, provided in said first device and storing at least said identification information on said first device and loads a driver corresponding to said first device.

3. The information processing apparatus according to claim 2, wherein at least one part of said virtual configuration space region associated with said second device is common to said configuration space of said first device in format.

4. The information processing apparatus according to claim 1, wherein said system loads at least one of the drivers corresponding to said first and second devices respectively at a time of booting of said information processing apparatus.

5. A method of loading a driver for an information processing apparatus adapted to include, besides at least one first device complying with predetermined bus interface specifications, at least one second device having interface specifications different from said predetermined bus interface specifications, said method comprising:
arranging a virtual configuration space region for said second device in a storage unit of said information processing apparatus, and storing at least virtual identification information on said second device in said virtual configuration space region; and
obtaining, for said second device, the virtual identification information from said virtual configuration space region associated with said second device, and loading a driver corresponding to said second device.

6. The method according to claim 5, further comprising
obtaining, for said first device included in said information processing apparatus, identification information on said first device from configuration space of said first device, said configuration space being provided in said first device and storing at least the identification information on said first device and loading a driver corresponding to said first device.

7. The method according to claim 6, wherein at least one part of said virtual configuration space region associated with said second device is common to said configuration space of said first device in format.

8. The method according to claim 5, wherein at least one of the drivers corresponding to said first and second devices respectively is loaded at a time of booting of said information processing apparatus.

9. A computer program for causing a computer adapted to have, besides at least one first device complying with predetermined bus interface specifications, at least one second device having interface specifications different from said predetermined bus interface specifications to execute:
arranging a virtual configuration space region for said second device in a storage unit of said information processing apparatus, and storing at least virtual identification information on said second device in said virtual configuration space region; and
obtaining, for said second device, the virtual identification information from said virtual configuration space region associated with said second device, and loading a driver corresponding to said second device.

10. The computer program according to claim 9, for causing said computer to execute:
obtaining, for said first device, identification information on said first device from configuration space of said first device, said configuration space being provided in said first device and storing at least the identification information on said first device and loading a driver corresponding to said first device.

11. The computer program according to claim 10, wherein at least one part of said virtual configuration space region associated with said second device is common to said configuration space of said first device in format.

12. The computer program according to claim 9, wherein at least one of the drivers corresponding to said first and second devices respectively is loaded at a time of booting of said information processing apparatus.

13. A computer system including at least one PCI (Peripheral Component Interface) device and at least one non-PCI device, said computer system comprising:
a storage region provided for a system BIOS (Basic Input/Output System), said storage region storing at least predetermined identification information on a virtual PCI device associated with said non-PCI device; and
an operating system; wherein, at a time of booting of said computer system, said operating system inquires said system BIOS so as to search for the PCI device included in said computer system;
said system BIOS returns to said operating system identification information on said PCI device, for said PCI device included in said computer system, and returns to said operating system the identification information on said virtual PCI device, for said non-PCI device; and
said operating system receives the identification information from said system BIOS, searches for a driver corresponding to said virtual PCI device from a driver library, and loads said driver searched for as a driver corresponding to said non-PCI device.

14. The computer system according to claim 13, wherein a header region for a configuration space of said virtual PCI device is disposed on a medium that can be referred to by said system BIOS, and a predetermined vendor ID and a predetermined device ID are stored in said header region as the predetermined identification information on said virtual PCI device.

15. The computer system according to claim 14, wherein when said non-PCI device uses an interrupt, information indicating that the interrupt is accommodated is set in an interrupt pin register provided for said header region for said configuration space of said virtual PCI device.

16. The computer system according to claim 15, wherein said operating system inquires said system BIOS whether the interrupt is accommodated in said virtual PCI device or not;
said system BIOS returns to said operating system the information indicating that the interrupt is accommodated in case said non-PCI device uses the interrupt; and
said operating system, on receipt of the information, determines that said virtual PCI device has the interrupt and registers a corresponding interrupt handler.

17. A method of controlling loading of a non-PCI device driver in a computer system including at least one PCI (Peripheral Component Interface) device and at least one non-PCI device, said method comprising:
arranging in a system BIOS (Basic Input/Output System) a storage region for storing at least predetermined identification information on a virtual PCI device associated with said non-PCI device;
inquiring by an operating system said system BIOS so as to search for the PCI device included in said computer system at a time of booting of said computer system;
returning by said system BIOS to said operating system identification information on said PCI device, for said PCI device included in said computer system, and returning by said system BIOS to said operating system the identification information on said virtual PCI device, for said non-PCI device; and
receiving the identification information from said system BIOS, searching for a driver corresponding to said virtual PCI device from a driver library, and loading said driver searched for as a driver corresponding to said non-PCI device, by said operating system.

18. The method of controlling loading of a driver according to claim 17, further comprising:
disposing a header region for a configuration space of said virtual PCI device on a medium that can be referred to by said system BIOS; and
storing a predetermined vendor ID and a predetermined device ID in said header region as the predetermined identification information on said virtual PCI device.

19. The method of controlling loading of a driver according to claim 18, further comprising:
setting information indicating that an interrupt is accommodated in an interrupt pin register provided for said header region for said configuration space of said virtual PCI device when said non-PCI device uses the interrupt.

20. The method of controlling loading of a driver according to claim 19, further comprising:
inquiring, by said operating system, said system BIOS whether the interrupt is accommodated in said virtual PCI device or not, at the time of booting of said computer system;
returning, by said system BIOS, to said operating system the information indicating that the interrupt is accommodated in case said non-PCI device uses the interrupt; and
determining, by said operating system, on receipt of the information, that said virtual PCI device has the interrupt and registering a corresponding interrupt handler, at the time of the booting.

21. A storage medium readable by a machine adapted to have, besides at least one first device complying with predetermined bus interface specifications, at least one second device having interface specifications different from said predetermined bus interface specifications, said storage medium tangibly embodying a program of instructions, executable by said machine, comprising:
arranging a virtual configuration space region for said second device in a storage unit of said information processing apparatus, and storing at least virtual identification information on said second device in said virtual configuration space region; and
obtaining, for said second device, the virtual identification information from said virtual configuration space region associated with said second device, and loading a driver corresponding to said second device.

22. The storage medium according to claim 21, wherein said program of instructions, executable by said machine, comprises:
obtaining, for said first device, identification information on said first device from configuration space of said first device, said configuration space being provided in said first device and storing at least the identification information on said first device and loading a driver corresponding to said first device.

23. The computer program according to claim 22, wherein at least one part of said virtual configuration space region associated with said second device is common to said configuration space of said first device in format.

24. The computer program according to claim 22, wherein at least one of the drivers corresponding to said first and second devices respectively is loaded at a time of booting of said machine.

25. An information processing apparatus comprising:
means for mounting at least one first device complying with predetermined bus interface specifications, and at least one second device having interface specifications different from said predetermined bus interface specifications;
means for storing a virtual configuration space region for said second device; said virtual configuration space region including at least virtual identification information on said second device; and
means for obtaining, for said second device, the virtual identification information from said virtual configuration space region associated with said second device, and loading a driver corresponding to said second device.

26. The information processing apparatus according to claim 25, further comprising means for obtaining, for said first device mounted in said information processing apparatus, identification information on said first device from configuration space of said first device, provided in said first device and storing at least said identification information on said first device and loading a driver corresponding to said first device.
